(19) United States
(12) Patent Application Publication
(10) Pub. No.: US 2026/0057529 A1
(43) Pub. Date: Feb. 26, 2026

(54) UNSUPERVISED DYNAMIC OBJECT VELOCITY ESTIMATION FROM MONOCULAR VIDEOS USING VOXEL CLUSTERING AND EGO MOTION COMPENSATION

(71) Applicant: QUALCOMM Incorporated, San Diego, CA (US)

(72) Inventors: Varun Ravi Kumar, San Diego, CA (US); Kiran Bangalore Ravi, Paris (FR); Senthil Kumar Yogamani, Headford, Galway (IE)

(21) Appl. No.: 18/590,227

(22) Filed: Feb. 28, 2024

(51) Int. Cl. G06T 7/20; G06T 3/18; G06T 15/08; G06V 10/762; G06V 10/77

(52) U.S. Cl. CPC G06T 7/20; G06T 3/18; G06T 15/08; G06V 10/762; G06V 10/7715

(57) ABSTRACT

Estimating a dynamic object velocity includes warping a first voxel grid generated from camera output images of a scene captured at a first time to a third voxel grid representing the scene at a second time; generating a voxel flow from the first time to the second time based at least in part on a second voxel grid generated from camera output images of the scene captured at the second time and the third voxel flow; determining a dynamic voxel flow based at least in part on the voxel flow and an ego motion flow; clustering the dynamic voxel flow to identify one or more object instances; and determining a velocity estimate for a dynamic object of the scene from motion of the one or more object instances in the dynamic voxel flow.

### TECHNICAL FIELD

This disclosure relates to computer vision.

### BACKGROUND

Autonomous vehicles and semi-autonomous vehicles may include an advanced driver assistance system (ADAS) using sensors and software to help operate the vehicles. An ADAS may use artificial intelligence (AI) and machine learning (ML) (e.g., deep neural network (DNN)) techniques for performing various operations for operating, piloting, and navigating the vehicles. For example, ML models may be used for object detection, lane and road boundary detection, safety analysis, drivable free-space analysis, control generation during vehicle maneuvers, and/or other operations. ML model-powered autonomous and semi-autonomous vehicles should be able to respond properly to a diverse set of situations, including interactions with emergency vehicles, pedestrians, animals, and a number of other obstacles.

ML has revolutionized many aspects of computer vision. For example, the computer vision task of object velocity estimation based on captured image data is useful for autonomous and semi-autonomous systems (such as autonomous and semi-autonomous vehicles) to perceive and navigate the surrounding environment. Yet, estimating the velocity of an object in image data by a ML model remains a challenging computer vision task.

### SUMMARY

This disclosure describes techniques and devices for estimating velocities of moving objects (e.g., dynamic objects) by analyzing images of a scene captured by a plurality of monocular cameras. The techniques of this disclosure may include encoding the images captured by the plurality of cameras at a first time and at a second time into a first voxel grid and a second voxel grid, respectively. The first and second voxel grids, along with ego pose data of an ego device (such as an autonomous vehicle), are analyzed to determine estimates of velocities of dynamic objects in the scene between the first time and the second time. The estimated dynamic velocities may be used by other computer vision tasks in a computer vision application, such as an ADAS. In one scenario, the estimated dynamic object velocities may be used for avoiding contact with the dynamic objects (e.g., other vehicles, pedestrians, etc.) by an ego vehicle or other system.

In one example, this disclosure describes a method comprising warping a first voxel grid generated from camera output images of a scene captured at a first time to a third voxel grid representing the scene at a second time, generating a voxel flow from the first time to the second time based at least in part on a second voxel grid generated from camera output images of the scene captured at the second time and the third voxel grid, determining a dynamic voxel flow based at least in part on the voxel flow and an ego motion flow, clustering the dynamic voxel flow to identify one or more object instances, and determining a velocity estimate for a dynamic object of the scene from motion of the one or more object instances in the dynamic voxel flow.

In another example, this disclosure describes an apparatus comprising a memory, and one or more processors implemented in circuitry and in communication with the memory, the one or more processors configured to warp a first voxel grid generated from camera output images of a scene captured at a first time to a third voxel grid representing the scene at a second time, generate a voxel flow from the first time to the second time based at least in part on a second voxel grid generated from camera output images of the scene captured at the second time and the third voxel grid, determine a dynamic voxel flow based at least in part on the voxel flow and an ego motion flow, cluster the dynamic voxel flow to identify one or more object instances, and determine a velocity estimate for a dynamic object of the scene from motion of the one or more object instances in the dynamic voxel flow.

In another example, this disclosure describes a non-transitory computer-readable storage medium storing instructions that, when executed, cause one or more processors to warp a first voxel grid generated from camera output images of a scene captured at a first time to a third voxel grid representing the scene at a second time, generate a voxel flow from the first time to the second time based at least in part on a second voxel grid generated from camera output images of the scene captured at the second time and the third voxel grid, determine a dynamic voxel flow based at least in part on the voxel flow and an ego motion flow, cluster the dynamic voxel flow to identify one or more object instances, and determine a velocity estimate for a dynamic object of the scene from motion of the one or more object instances in the dynamic voxel flow.

In another example, this disclosure describes an apparatus comprising means for warping a first voxel grid generated from camera output images of a scene captured at a first time to a third voxel grid representing the scene at a second time, means for generating a voxel flow from the first time to the second time based at least in part on a second voxel grid generated from camera output images of the scene captured at the second time and the third voxel grid, means for determining a dynamic voxel flow based at least in part on the voxel flow and an ego motion flow, means for clustering the dynamic voxel flow to identify one or more object instances, and means for determining a velocity estimate for a dynamic object of the scene from motion of the one or more object instances in the dynamic voxel flow.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle in accordance with the techniques of this disclosure.

FIG. 2 is a block diagram illustrating an example computing system that may perform the techniques of this disclosure.

FIG. 3 is a block diagram illustrating dynamic object velocity estimation, in accordance with the techniques of this disclosure.

FIG. 4 is a flow diagram illustrating an example method for dynamic object velocity estimation in accordance with the techniques of this disclosure.

FIG. 5 is a block diagram illustrating details of dynamic object velocity estimation, in accordance with the techniques of this disclosure.

FIG. 6 illustrates processing of voxel grids in accordance with the techniques of this disclosure.

FIG. 7 illustrates voxel warping in accordance with the techniques of this disclosure.

FIG. 8 illustrating object clustering in accordance with the techniques of this disclosure.

FIG. 9 is a flow diagram illustrating an example method for dynamic object velocity estimation in accordance with the techniques of this disclosure.

### DETAILED DESCRIPTION

Aspects of the present disclosure provide apparatuses, methods, computing systems and non-transitory computer-readable media for performing dynamic object velocity estimation from images produced by monocular cameras. Estimating dynamic object velocity is a useful task in computer vision applications, which may be used in object detection and tracking features. For example, dynamic object velocity estimation is useful for determining obstacle avoidance for vehicles driving autonomously or semi-autonomously or with assistance, drones flying autonomously or semi-autonomously, warehouse or household robots operating autonomously or semi-autonomously, spatial scene understanding, and other examples.

Temporal consistency is useful for many three-dimensional (3D) perception tasks in computer vision applications (such as ADAS). Existing approaches seek to provide temporal consistency during computer vision processing but do not explicitly handle dynamic (e.g., moving) objects. Some existing approaches simply concatenate sequential bird's eye view (BEV) feature maps over time, but these approaches also do not explicitly handle dynamic objects and often lead to ghosting and/or blurring artifacts in processed images. Furthermore, BEV feature maps do not directly represent the local gradient or curvature of a road surface, and BEV feature maps do not operate with sensors with different fields of view (FOVs) in the z dimension (e.g., vertically stacked LIDARs, radars, or cameras).

3D voxel maps provide a 360-degree representation of a scene around a vehicle (or other system), which may make motion planning and prediction more robust as compared to only having a local ground plane map (as in the BEV case). Some existing voxel-based approaches use a sliding window of grids and maintain a running background model to capture the static scene (in some cases by applying a median filter) and to separate dynamic objects from static objects. A more advanced existing voxel-based approach maintains probabilistic occupancy grids and performs Bayesian updates on each voxel's occupancy state over time. This allows for maintaining a persistent map of the static environment of the scene while capturing dynamic changes. However, similar issues arise in the voxel-based approaches that concatenate voxel grid maps over time without change detection.

The techniques described herein address at least some of the disadvantages of prior approaches to perform velocity estimation for voxelized scene components from multi-view camera inputs, without processing radar sensor data (e.g., for direct velocity measurement) or light detection and ranging (LIDAR) sensor data (e.g., for direct depth measurements). A plurality of monocular image sensors may be used to capture images of a scene at a point in time. Monocular image sensors tend to be ubiquitous, low cost, small, and low power, which makes such sensors desirable in a wide variety of applications, such as in vehicles, robots, drones, etc. The techniques described herein do not require stereo vision data from stereo cameras, optical flow processing, or monocular depth estimation processing. In an aspect, the techniques described herein may be used to estimate the velocity of objects without explicit depth information from proxy networks. In an aspect, the techniques may be used to train networks (e.g., ML models) to regress 3D voxel motion directly from sequential voxelized image data from cameras in a self-supervised manner.

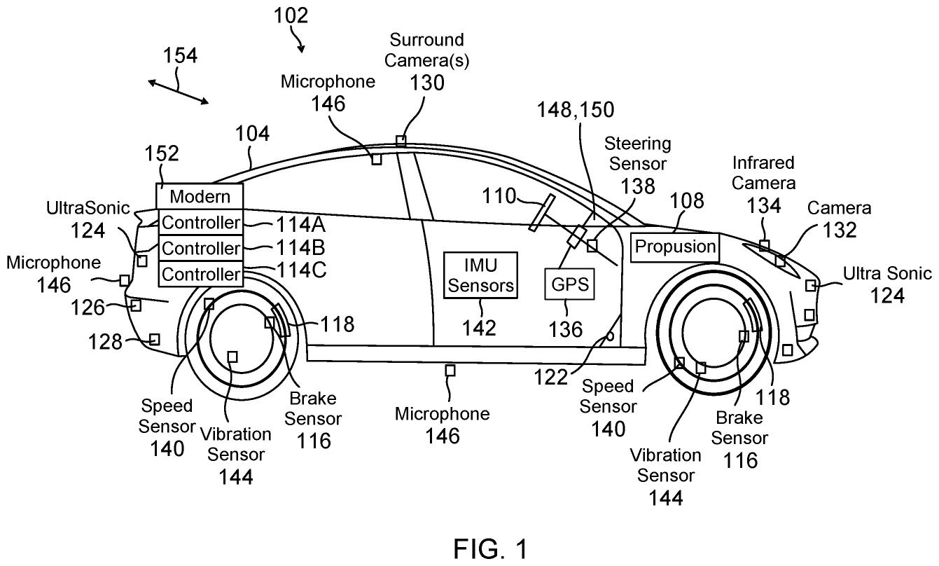

FIG. 1 is a diagram of an example autonomous vehicle, in accordance with the techniques of this disclosure. Autonomous vehicle 102 in the example shown may comprise any vehicle (such as a car, van or truck) that can accommodate a human driver and/or human passengers. Autonomous vehicle 102 may include a vehicle body 104 suspended on a chassis, in this example comprised of four wheels and associated axles.

A propulsion system 108, such as an internal combustion engine, hybrid electric power plant, or even all-electric engine, may be connected to drive some or all the wheels via a drive train, which may include a transmission (not shown). A steering wheel 110 may be used to steer some or all the wheels to direct autonomous vehicle 102 along a desired path when the propulsion system 108 is operating and engaged to propel the autonomous vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computer systems that may be configured to perform deep learning and AI functionality and output autonomous operation commands to autonomous vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide AI functionality for in-camera sensors, and controller 114D (not shown in FIG. 1) may provide infotainment functionality and provide additional redundancy for emergency situations.

Controller 114 may send command signals to operate vehicle brakes (using brake sensor 116) via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”), a network inside modern vehicles used to control brakes, acceleration, steering, windshield wipers, and the like. The CAN bus may be configured to have dozens of nodes, each with its own unique identifier (CAN ID). The bus may be read to find steering wheel angle, ground speed, engine revolutions per minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be provided with dedicated hardware and software, allowing control of throttle, brake, steering, and shifting. The hardware may provide a bridge between the vehicle's CAN bus and the controller 114, forwarding vehicle data to controller 114 including the turn signals, wheel speed, acceleration, pitch, roll, yaw, Global Positioning System (GPS) data, tire pressure, fuel level, sonar, brake torque, and others. Similar actuation controllers may be configured for any make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more surround cameras 130 (typically such cameras are located at various places on vehicle body 104 to image areas all around the vehicle body), one or more cameras 132 (in an aspect, at least one such camera may face forward to provide object recognition in the vehicle's path), one or more infrared cameras 134, GPS unit 136 that provides location coordinates, a steering sensor 138 that detects the steering angle, speed sensors 140 (one for each of the wheels), an inertial sensor or inertial measurement unit (IMU) 142 that monitors movement of vehicle body 104 (this sensor may be, for example, an accelerometer(s) and/or a gyro-sensor(s) and/or a magnetic compass(es)), tire vibration sensors 144, and microphones 146 placed around and inside the vehicle. Other sensors may also be used.

Controller 114 may also receive inputs from an instrument cluster 148 and may provide human-perceptible outputs to a human operator via human-machine interface (HMI) display(s) 150, an audible annunciator, a loudspeaker and/or other means. In addition to traditional information such as velocity, time, and other well-known information, HMI display may provide the vehicle occupants with information regarding maps and vehicle's location, the location of other vehicles (including an occupancy grid) and even the controller's identification of objects and status. For example, HMI display 150 may alert the passenger when the controller has identified the presence of another vehicle or other object, water puddle, stop sign, caution sign, or changing traffic light and is taking appropriate action, giving the vehicle occupants peace of mind that the controller is functioning as intended. In an aspect, instrument cluster 148 may include a separate controller/processor configured to perform deep learning and AI functionality.

Autonomous vehicle 102 may collect data that is preferably used to help train and refine the neural networks used for autonomous driving. The autonomous vehicle 102 may include modem 152, preferably a system-on-a-chip (SoC) that provides modulation and demodulation functionality and allows the controller 114 to communicate over the wireless network 154. Modem 152 may include a radio frequency (RF) front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: long term evolution (LTE), wideband code division multiple access (WCDMA), universal mobile telecommunications framework (UMTS), global system for mobile communications (GSM), CDMA2000, or other known and widely used wireless protocols.

It should be noted that, compared to other sensors, cameras 130-134 may generate a richer set of features at a fraction of the cost. Thus, autonomous vehicle 102 may include a plurality of cameras 130, 132, capturing images around the entire periphery of the autonomous vehicle 102. Camera type and lens selection depends on the nature and type of function. Autonomous vehicle 102 may have a mix of camera types and lenses to provide complete coverage around the autonomous vehicle 102; in general, narrow lenses do not have a wide field of view but can see farther. All cameras on autonomous vehicle 102 may support interfaces such as Gigabit Multimedia Serial link (GMSL) and Gigabit Ethernet.

In some examples, cameras 130, 132 may be responsible for capturing high-resolution images and processing them in real time. The output images of such camera-based systems may be used in applications such as object detection, object velocity estimation, depth estimation, and/or pose detection, including the detection and recognition of objects, such as other vehicles, pedestrians, traffic signs, barriers, curbs, and lane markings, etc. Cameras 130, 132 may be particularly good at capturing color and texture information, which is useful for accurate object recognition and classification.

Cameras 130, 132 may generally be any type of monocular camera configured to capture video or image data in the environment around autonomous vehicle 102. For example, cameras 130, 132 may include a front facing camera (e.g., a front bumper camera, a front windshield camera, and/or a dashcam), a back facing camera (e.g., a backup camera), side facing cameras (e.g., cameras mounted in sideview mirrors), or surround cameras. Cameras 130, 132 may include color cameras or grayscale cameras.

In an aspect, a controller 114 may receive one or more images acquired by a plurality of cameras 130, 132. Controller 114 may include a portion of an ADAS to perform dynamic object velocity estimation in accordance with the techniques of this disclosure. For example, controller 114 may be configured to receive camera images generated by a plurality of cameras 130, 132 of a scene surrounding autonomous vehicle 102. Controller 114 may then perform dynamic object velocity estimation processing using one or more of camera parameters, the camera output images, and ego pose data for the cameras and/or autonomous vehicle 102.

Although the techniques of this disclosure are described with respect to implementation in autonomous vehicle 102 (including ADAS), in other implementations the techniques may be used in drones, robots, ships, airplanes, helicopters, motorcycles, all-terrain vehicles (ATVs), or other applications involving moving objects.

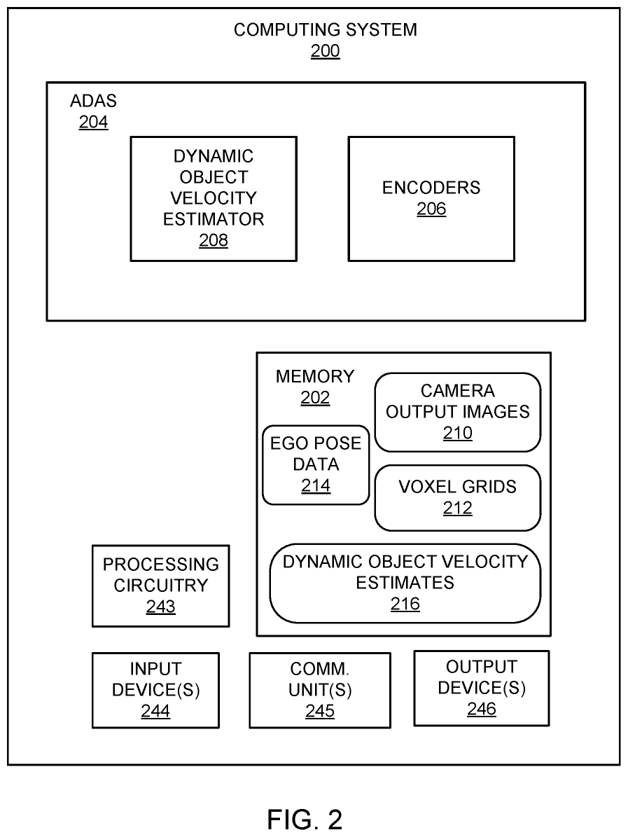

FIG. 2 is a block diagram illustrating an example computing system that may perform the techniques of this disclosure. As shown, computing system 200 comprises processing circuitry 243 and memory 202 for executing ADAS 204, which may represent an example instance of any controller 114 described in this disclosure, such as controllers 114A, 114B, and 114C of FIG. 1.

In an aspect, ADAS 204 may include encoders 206 and dynamic object velocity estimator 208. A plurality of encoders 206 encode images captured by a plurality of cameras 130, 132 (denoted herein as camera output images 210) of a scene at points in times into a plurality of voxel grids 212. Dynamic object velocity estimator 208 analyzes the voxel grids, using ego pose data 214, to identify dynamic objects in the voxel grids and estimate the velocities of the dynamic objects. ADAS 204 may then use the dynamic object velocity estimates 216 in further ADAS processing, such as avoiding contact with the dynamic objects in the scene (e.g., other vehicles, pedestrians, etc.). Such dynamic object avoidance processing may help improve the safety of operating the autonomous vehicle 102. Ego pose data 214 includes position and rotation data of an ego device, such as an autonomous vehicle, drone, robot, ship, airplane, helicopter, motorcycle, or ATV.

Computing system 200 may be implemented as any suitable computing system accessible by controller 114, such as one or more server computers, workstations, laptops, mainframes, appliances, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure. Processing circuitry 243 may include one or more central processing units (CPUs), such as single-core or multi-core CPUs, graphics processing units (GPUs), digital signal processor (DSPs), neural processing unit (NPUs), multimedia processing units, and/or the like.

An NPU is a specialized circuit configured for implementing control and arithmetic logic for executing machine learning algorithms, such as algorithms for processing artificial neural networks (ANNs), DNNs, random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store camera output images 210 received from one or more of cameras 130, 132, a plurality of voxel grids 212, a plurality of dynamic object velocity estimates 216, and ego pose data 214, as well as instructions of ADAS 204, including a plurality of encoders 206 and dynamic object velocity estimator 208.

Processing circuitry 243 and memory 202 may provide an operating environment or platform for one or more modules or units (e.g., ADAS 204, including a plurality of encoders 206 and dynamic object velocity estimator 208, etc.), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 204, including a plurality of encoders 206 and dynamic object velocity estimator 208, using virtualization modules, such as a virtual machine or container executing on underlying hardware. One or more of such modules may execute as one or more services of an operating system or computing platform. Aspects of ADAS 204, including a plurality of encoders 206 and dynamic object velocity estimator 208, may execute as one or more executable programs at an application layer of a computing platform.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

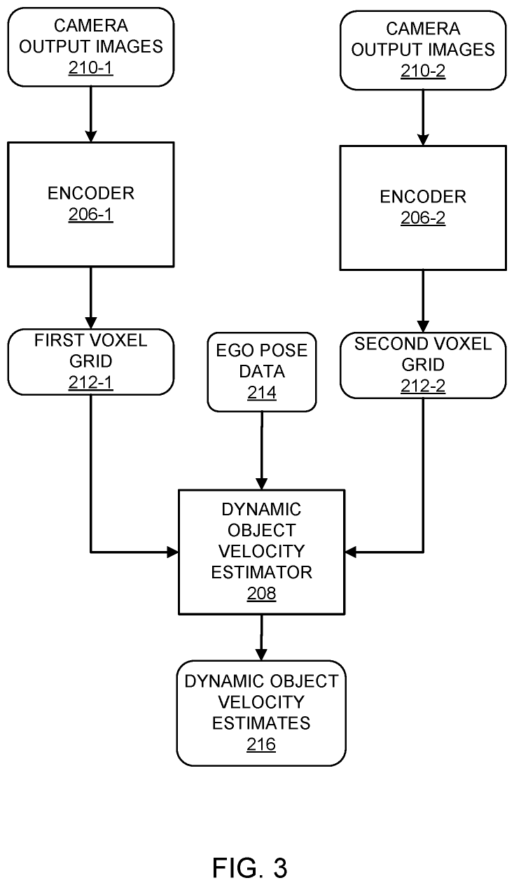

FIG. 3 is a block diagram illustrating dynamic object velocity estimation in accordance with the techniques of this disclosure. Dynamic object velocity estimator 208 estimates velocities of dynamic 3D objects from monocular camera images at two points in time, denoted t₀ and tₖ herein. In some examples, dynamic object velocity estimator 208 estimates velocities of dynamic 3D objects without having access to depth sensors, such LIDAR or radar devices. Camera output images 210 include a red/green/blue (RGB) image (or other color format) from each of a plurality of cameras 130, 132 captured of a scene (e.g., surrounding autonomous vehicle 102) at a point in time. For example, camera output images 210-1 includes images captured by the plurality of cameras 130, 132 at a first time t₀, and camera output images 210-2 includes images captured by the plurality of cameras 130, 132 at a second time tₖ. In an aspect, the second time is after the first time and movement (including positions and velocities) of objects of the scene between the first time and the second time may be estimated.

Each encoder of the plurality of encoders 206 may use a visual encoder network (not shown in FIG. 3) to process camera output images 210. Encoder processing may include extracting features from the camera output images into one or more data structures called feature maps that represent spatial information of the scene at a point in time. Encoder processing may apply a voxelization process to convert the one or more feature maps into 3D voxel grids. The voxelization process includes discretizing the 3D space of the scene into small volumetric elements called voxels (e.g., cubes). Each voxel represents a small portion of the 3D space. Thus, encoder 206-1 processes camera output images 210-1 from time t₀ to generate first voxel grid 212-1 (also denoted herein as V₀) and encoder 206-2 processes camera output images 210-2 from time tₖ to generate second voxel grid 212-1 (also denoted herein as Vₖ). In an aspect, encoder 206-1 and encoder 206-2 may implement voxel encoding processing as described in “Voxel-Net: End-to-End Learning for Point Cloud Based 3D Object Detection” by Yin Zhou, et al., Nov. 17, 2017, although in other implementations other encoding processing techniques may also be used.

Dynamic object velocity estimator 208 uses first voxel grid 212-1, second voxel grid 212-2, and ego pose data 214 to determine dynamic object velocity estimates 216 for dynamic objects detected in the scene captured by the camera output images 210-1, 210-2. In an aspect, ego pose data 214 may be obtained from odometry data corresponding to autonomous vehicle 102, including rotation and translation data. In an aspect, ego pose data 214 includes transformations that describe positions and orientations of cameras 130, 132 at points in time.

Ego pose generally refers to the position and orientation of a camera and/or vehicle in a world coordinate frame over time. Ego pose is used for aligning frames captured at different times. Ego pose data may be available from GPS data and/or inertial navigation system (INS) data and may also be calculated using a pose estimation network. Ego pose data is often received from onboard vehicle sensors like an IMU (inertial measurement unit) and wheel encoders. An IMU provides angular velocity and linear acceleration to estimate orientation and position changes over time. Wheel encoders track distance traveled.

The ego pose will change over time as the vehicle/camera moves and rotates relative to the world. For example, between frames t0 and tk, the position components of the ego pose will reflect any translation of the camera, while orientation reflects its rotation. Providing continuous ego pose estimates enables deterministically warping frames to a common coordinate system. The changing ego pose over time models the camera motion.

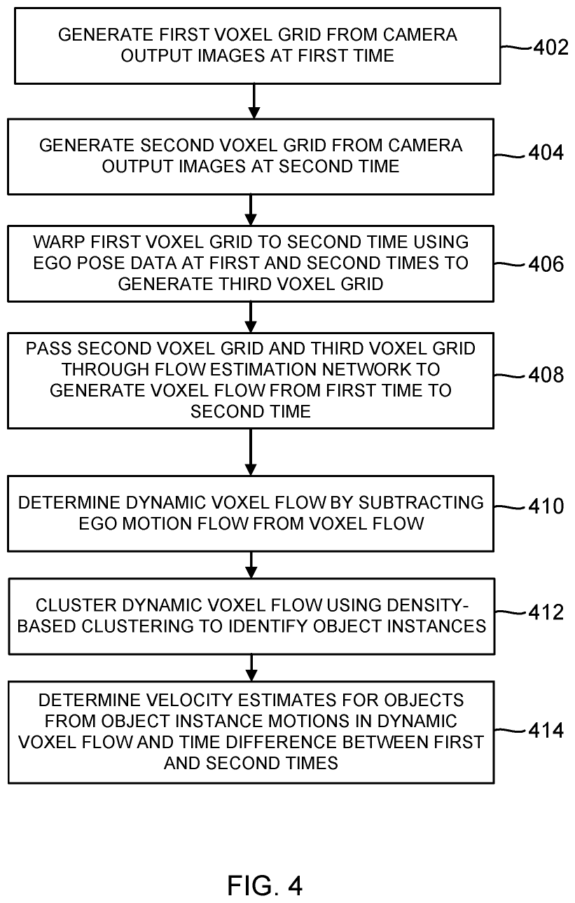

FIG. 4 is a flow diagram illustrating an example method for dynamic object velocity estimation in accordance with the techniques of this disclosure. Although described with respect to computing system 200 (FIG. 2), it should be understood that other computing systems may be configured to perform a method similar to that of FIG. 4. At block 402, encoder 206-1 generates a first voxel grid 212-1 (e.g., V₀) from camera output images 210-1 at a first time t₀. At block 404, encoder 206-2 generates a second voxel grid 212-2 (e.g., Vₖ) from camara output images 210-2 at a second time tₖ. By converting RGB images into a 3D voxel grid representation, a data structure format is provided that may be used for further analysis and processing (including estimating dynamic flows of moving objects as described herein). The voxel grids organize the visual information of the scene into a format that facilitates understanding and manipulation of the spatial relationships within the scene (which may be useful for motion estimation and object tracking processing).

At block 406, dynamic object velocity estimator 208 warps first voxel grid 212-1 to the second time tₖ, using ego pose data 214 at the first and second times, to generate a third voxel grid 212-3 (also denoted herein as V_{0->k}, not shown in FIG. 3). At block 408, dynamic object velocity estimator 208 passes second voxel grid 212-2 and the third voxel grid 212-3 through an internal flow estimation network to generate a voxel flow from the first time t₀ to the second time tₖ. An example voxel flow estimation network may take the current and reference voxel grids as input and predict a corresponding voxel flow field. The flow estimation network may be based on an encoder-decoder style network with 3D convolutions (e.g., PWC-Net—A two-stream 3D CNN that regresses offset fields for optical flow). This or other variants could potentially be adapted for voxel flow.

At block 410, dynamic object velocity estimator 208 determines a dynamic voxel flow by subtracting the flow caused by ego motion (as represented by ego pose data 214 from the first time t₀ to the second time tₖ) from the voxel flow. At block 412, dynamic object velocity estimator 208 clusters the dynamic flow using a density-based clustering process to identify object instances. At block 414, dynamic object velocity estimator 208 uses motions of object instances represented in the dynamic flow and the difference between the first time t₀ and the second time tₖ to estimate velocities of the dynamic objects corresponding to the object instances.

To estimate velocities, the dynamic voxel flow output of the network (e.g., object velocity estimator 208) is first clustered into objects. For each cluster, the average voxel flow can be computed. Then, using the known time difference Δt between the input frames, the average voxel displacement Δx can be converted into a velocity estimate v: v=Δx/Δt. For example, if a cluster of voxels was on average displaced 2 meters in the x direction over a time period of 1 second, the estimated velocity in that direction would be: vx=2 m/1 s=2 m/s. This process may be done individually for the x, y, z components of each cluster to obtain the full 3D velocity vector. In other examples, a regression network could also be trained to directly estimate the velocity from the dynamic voxel flow input in a supervised manner, given suitable training labels.

Thus, the techniques of this disclosure leverage data from monocular images, ego poses, and voxel flow estimation to estimate the velocities of dynamic objects in a scene. The techniques incorporate a multi-step process involving warping, flow estimation, and clustering to provide a detailed framework for dynamic object velocity estimation without using radar or LIDAR sensors. In an aspect, the dynamic object velocity estimates may be used for object avoidance processing in an ADAS.

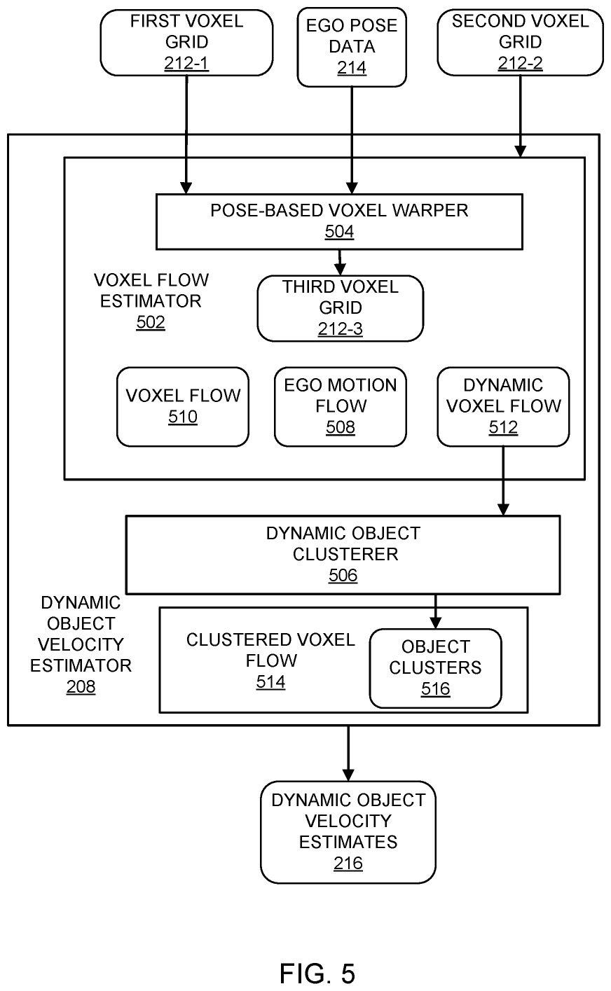

FIG. 5 is a block diagram illustrating details of dynamic object velocity estimation, in accordance with the techniques of this disclosure. In an aspect, dynamic object velocity estimator 208 includes voxel flow estimator 502. Voxel flow estimator 502 reads first voxel grid 212-1 (e.g., a reference voxel grid V₀), second voxel grid 212-2 (e.g., a current voxel grid Vₖ) and ego pose data 214 at the first time t₀ and the second time tₖ and generates dynamic voxel flow 512.

Pose-based voxel warper 504 of voxel flow estimator 502 warps first voxel grid 212-1 to a pseudo third voxel grid 212-3 at the second time tₖ using ego pose data 214 at the first and second times. This processing transforms first voxel grid 212-1 to the coordinate system of the second time tₖ as third voxel grid 212-3. In an aspect, pose-based voxel warping is deterministic and relies on extrinsic transformation matrices.

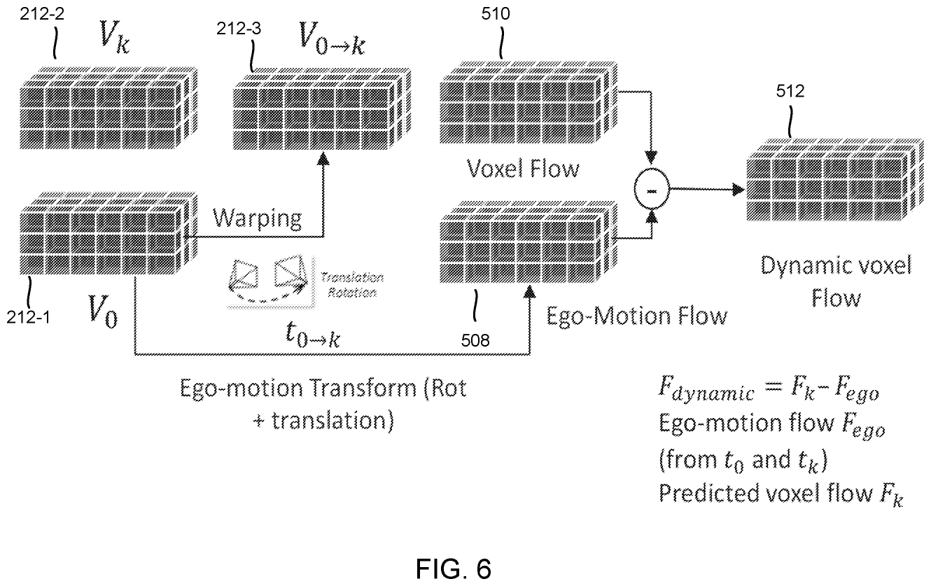

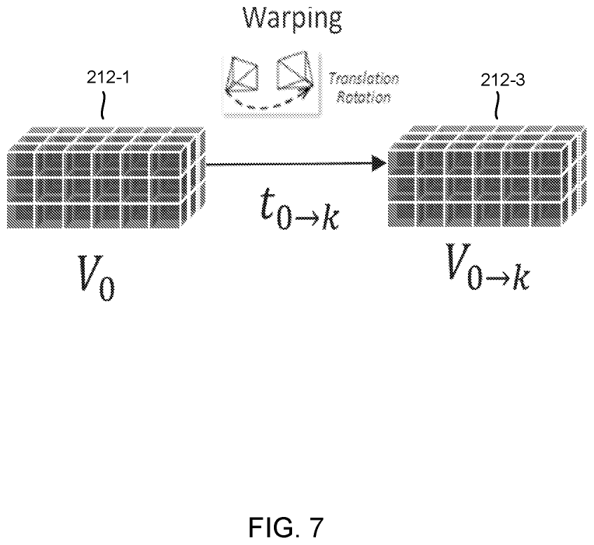

FIG. 6 illustrates processing of voxel grids in accordance with the techniques of this disclosure. FIG. 7 illustrates voxel warping in accordance with the techniques of this disclosure. FIG. 7 shows first voxel grid 212-1 being warped as third voxel grid 212-3.

In an aspect, pose-based voxel warper 504 processes the first voxel grid 212-1 and ego pose data 214 as follows. The transformation between a camera's pose at t₀ and tₖ can be represented by a 4×4 extrinsic transformation matrix denoted as T_{0→k}. This matrix encapsulates the translation and rotation used to bring the t₀ frame into alignment with the coordinate system of tₖ. Mathematically, this transformation can be represented as shown in Equation 1.

$${T}_{0 \to k} = [ {R}_{0 \to k} \vert {t}_{0 \to k} ] \qquad \underline{Equation 1}$$

where R_{0→k} is a 3×3 rotation matrix representing the rotation component of the transformation and t_{0→k} is a 3×1 translation vector representing the translation component of the transformation.

Given the transformation matrix T_{0→k}, the transformation matrix can be applied to each voxel's coordinates in Vₒ to obtain the corresponding coordinates in V_{0→k}. For a voxel coordinate (x, y, z) in Vₒ, the transformed coordinate (x′, y′, z′) in V_{0→k} can be computed using the transformation matrix as shown in Equation 2.

$${[ {x}^{′} {y}^{′} {z}^{′} 1 ]}^{′} = {T}_{0 \to k} * {[ xyz 1 ]}^{′} \qquad \underline{Equation 2}$$

where [xyz1]′ represents the homogenous coordinates of the voxel in Vₒ.

After transforming the voxel coordinates, fractional voxel coordinates in V_{0→k} may exist. In this case, interpolation may be performed to determine the voxel intensity or value at the non-integer coordinates. For example, a trilinear interpolation method may be performed. Other common interpolation methods may also be used.

The result of the warping process is a warped voxel grid V_{0→k} as shown in FIG. 7. Third voxel grid 212-3 V_{0→k} represents the reference frame Vₒ transformed into the coordinate system of time tₖ. Thus, pose-based voxel warper 504 aligns the first voxel grid 212-1 (e.g., the reference voxel grid V₀) with the coordinate system of current interest (e.g., of the second voxel grid 212-2 Vₖ), enabling further processing in that frame of reference. This is useful for accurate motion estimation of dynamic objects of the scene.

Voxel flow estimator 502 determines ego motion flow 508 from first voxel grid 212-1 and ego pose data 214. Ego motion flow 508 represents motion of the ego vehicle (e.g., autonomous vehicle 102) as represented by ego pose data 214 from the first time to the second time.

Voxel flow estimator 502 uses the ego poses at times t0 and tk to calculate the rigid body transformation between the two time steps. This gives the rotation and translation of the camera. Voxel flow estimator 502 applies the rotation and translation matrices to each voxel coordinate in the reference grid V0 to transform it to the coordinates at tk. The difference between the original voxel coordinate in V0 and its transformed coordinate gives its motion vectors due only to camera ego motion. This process is repeated for all voxels, resulting in a dense 3D flow field called the ego motion flow (Fego) 508. Ego motion flow 508 captures the apparent motion of static scene points due only to camera motion/rotation. Voxel flow estimator 502 subtracts ego motion flow 508 (Fego) from the raw voxel flow F between grids Vk and V0→k to isolate any remaining dynamic object motion: Fdynamic=F−Fego.

Voxel flow estimator 502 determines voxel flow 510, using a flow estimation network, as the difference between second voxel grid 212-2 and third voxel grid 212-3. Voxel flow estimator 502 subtracts ego motion flow 508 from voxel flow 510 to isolate dynamic voxel flow 512 (as shown in FIG. 6). Dynamic voxel flow 512 represents the motion of voxels between the two points in time.

Voxel flow estimator 502 takes in the current voxel grid Vk and the transformed reference grid V0→k as input. Voxel flow estimator 502 may be implemented as an encoder-decoder style network based on 3D convolutional layers. The encoder extracts multi-scale feature representations from the input grids. The decoder portion takes these learned features and predicts a dense 3D flow field between the input grids. Each voxel in the output flow field stores a 3D vector indicating the displacement/motion of that voxel from V0→k to Vk. The network of voxel flow estimator 502 may be trained in a self-supervised manner using a photometric consistency loss. The network learns to predict flows that minimize differences between Vk and the warped V0→k grid. Skip connections may fuse low-level features with semantic features to capture fine-grained motions. Multiple flow prediction heads at different scales can help capture motions at various levels of detail. The predicted flow field then undergoes the ego-motion removal process to isolate dynamic object motions.

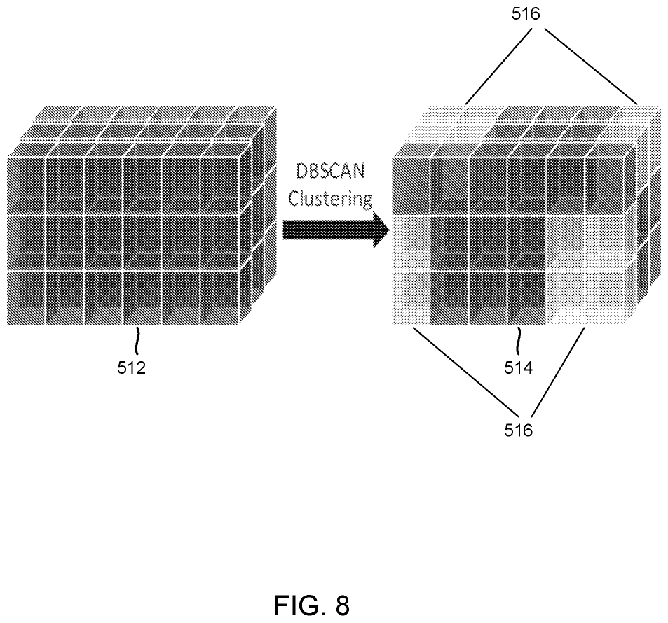

Voxel flow estimator 502 includes dynamic object clusterer 506 to analyze dynamic voxel flow 512 and determine a clustered voxel flow 514, the clustered dynamic flow including a plurality of object clusters 516 representing grouped dynamic voxels (e.g., representing the same moving object) as shown in FIG. 8. In an aspect, dynamic object clusterer 506 clusters voxels of dynamic voxel flow 512 using voxel positions and flow vectors as clustering parameters. In an aspect, dynamic object clusterer 506 may use an unsupervised cluster approach to generate object instances based on object densities.

Each voxel in dynamic voxel flow 512 has both a position and a flow vector. The position (x, y, z) represents the spatial coordinates of the voxel, and the flow vector (u, v, w) indicates the motion in each direction. For clustering, both the voxel position and flow vector information are considered. This means that the clustering algorithm takes into account where the voxels are located and how they are moving over time. In an aspect, an unsupervised density-based clustering algorithm such as DBSCAN (Density-Based Spatial Clustering of Applications with Noise) may be used. DBSCAN is described in “A Density-based Algorithm for Discovering Clusters in Large Spatial Databases with Noise” by Martin Ester, et al., Knowledge Discovery and Data Mining (KDD)-96 Proceedings, pp. 226-231, 1996. DBSCAN groups points that are closely packed together based on a specified distance threshold ∈ and a minimum number of points minₛₐₘₚₗₑₛ required to form a cluster. In other implementations, other clustering processes may be used instead of DBSCAN.

In this context, DBSCAN is applied by dynamic object clusterer 506 to dynamic voxel flow 512. The spatial coordinates (x, y, z) of each voxel, along with the flow vectors (u, v, w), are used as features for clustering:

$$DBSCAN ( X , ∈ , {min}_{samples} )$$

where X is an input data matrix with features (voxel positions and flows);
∈ is the maximum distance between two samples for one to be considered as part of the neighborhood of the other; and
minₛₐₘₚₗₑₛ is the number of samples in a neighborhood for a point to be considered as a core point.

After applying DBSCAN to generate clustered voxel flow 514, each voxel is assigned to a cluster. Points that do not belong to any cluster may be considered as noise or outliers. The generated clusters (e.g., objects clusters 516) represent different object instances in the scene. Each object cluster includes dynamic voxels that are likely part of the same moving object.

While DBSCAN may be used for density-based clustering, there are alternative clustering algorithms that may also be used, such as K-means clustering, mean-shift clustering, and agglomerative hierarchical clustering. K-means clustering is a widely used clustering algorithm that partitions data into K clusters based on similarity of features. However, K-means clustering may not be as suitable for density-based data as DBSCAN. Mean-shift clustering is a non-parametric clustering algorithm that does not assume any prior knowledge about the number of clusters. Mean-shift clustering may be effective for density-based clustering. Agglomerative hierarchical clustering builds a hierarchy of clusters by successively merging or splitting clusters. This approach may be effective for a wide range of data distributions. The choice of clustering algorithm to be used may be based on the specific characteristics of the image data and the desired outcome of the clustering process.

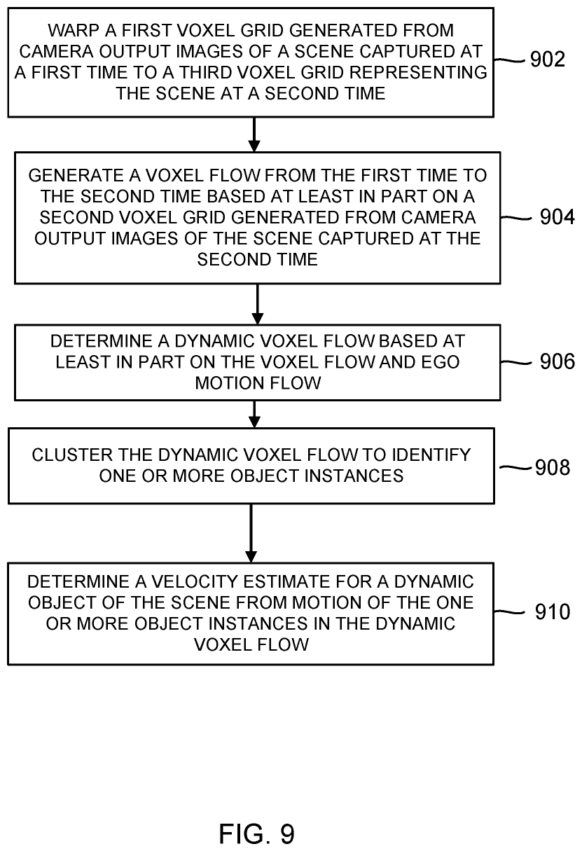

FIG. 9 is a flow diagram illustrating an example method for dynamic object velocity estimation in accordance with the techniques of this disclosure. Although described with respect to computing system 200 (FIG. 2), it should be understood that other computing systems may be configured to perform a method similar to that of FIG. 9.

At block 902, in an aspect, pose-based voxel warper 504 of voxel flow estimator 502 of dynamic object velocity estimator 208 warps a first voxel grid generated from camera output images of a scene captured at a first time to a third voxel grid representing the scene at a second time.

At block 904, in an aspect, voxel flow estimator 502 generates a voxel flow from the first time to the second time based at least in part on a second voxel grid generated from camera output images of the scene captured at the second time and the third voxel flow.

At block 906, in an aspect, voxel flow estimator 502 determines a dynamic voxel flow based at least in part on the voxel flow and an ego motion flow.

At block 908, in an aspect, dynamic object clusterer 506 of dynamic object velocity estimator 208 clusters the dynamic voxel flow to identify one or more object instances.

At block 910, in an aspect, dynamic object velocity estimator 208 determines a velocity estimate 216 for a dynamic object of the scene from motion of the one or more object instances in the dynamic voxel flow.

The techniques described herein provide velocity estimates for dynamic objects in a scene based at least in part on image data captured by inexpensive monocular cameras (which may already be installed on autonomous vehicles or other systems for perception tasks such as traffic light and sign recognition), without the need for expensive depth sensors such as LIDAR or radar. The techniques avoid complexities of data association and multi-object tracking needed for triangulating velocities from detections in camera-only systems. The techniques use a voxel representation which encodes free space and occluded areas, enabling velocity estimation even for occluded objects. Furthermore, building a voxel representation of a scene may be useful for other tasks of ADAS 204 such as planning, prediction, simulation, etc.

The following numbered clauses illustrate one or more aspects of the devices and techniques described in this disclosure.

Clause 1. A method comprising: warping a first voxel grid generated from camera output images of a scene captured at a first time to a third voxel grid representing the scene at a second time; generating a voxel flow from the first time to the second time based at least in part on a second voxel grid generated from camera output images of the scene captured at the second time and the third voxel grid; determining a dynamic voxel flow based at least in part on the voxel flow and an ego motion flow; clustering the dynamic voxel flow to identify one or more object instances; and determining a velocity estimate for a dynamic object of the scene from motion of the one or more object instances in the dynamic voxel flow.

Clause 2. The method of Clause 1, wherein generating the voxel flow comprises passing the second voxel grid and the third voxel grid through a flow estimation network.

Clause 3. The method of any of Clauses 1-2, wherein determining the dynamic voxel flow comprises subtracting the ego motion flow from the voxel flow.

Clause 4. The method of any of Clauses 1-3, wherein the ego motion flow represents motion of an ego device, as represented by ego pose data, from the first time to the second time.

Clause 5. The method of Clause 4, wherein warping the first voxel grid to generate the third voxel grid comprises warping the first voxel grid using the ego pose data at the first and second times.

Clause 6. The method of any of Clauses 4-5, wherein the ego device comprises an autonomous vehicle.

Clause 7. The method of any of Clauses 1-6, wherein clustering the dynamic voxel flow comprises unsupervised density-based clustering.

Clause 8. The method of any of Clauses 1-7, wherein determining the velocity estimate for the dynamic object of the scene comprises determining the velocity estimate using a difference between the first time and the second time.

Clause 9. The method of any of Clauses 1-8, further comprising: generating the first voxel grid by extracting features from the camera output images into one or more feature maps and applying a voxelization process to convert the one or more feature maps into the first voxel grid.

Clause 10. The method of any of Clauses 1-9, wherein the camera output images of the scene are captured by a plurality of monocular cameras.

Clause 11. The method of any of Clauses 1-10, wherein the dynamic voxel flow represents motion of voxels between the first time and the second time.

Clause 12. The method of any of Clauses 1-11, further comprising: controlling an operation of a vehicle based at least in part on the velocity estimate for the dynamic object.

Clause 13. An apparatus comprising: a memory; and one or more processors implemented in circuitry and in communication with the memory, the one or more processors configured to: warp a first voxel grid generated from camera output images of a scene captured at a first time to a third voxel grid representing the scene at a second time; generate a voxel flow from the first time to the second time based at least in part on a second voxel grid generated from camera output images of the scene captured at the second time and the third voxel grid; determine a dynamic voxel flow based at least in part on the voxel flow and an ego motion flow; cluster the dynamic voxel flow to identify one or more object instances; and determine a velocity estimate for a dynamic object of the scene from motion of the one or more object instances in the dynamic voxel flow.

Clause 14. The apparatus of Clause 13, wherein to generate the voxel flow, the one or more processors are further configured to: pass the second voxel grid and the third voxel grid through a flow estimation network.

Clause 15. The apparatus of any of Clauses 13-14, wherein to determine the dynamic voxel flow, the one or more processors are further configured to: subtract the ego motion flow from the voxel flow.

Clause 16. The apparatus of any of Clauses 13-15, wherein the ego motion flow represents motion of an ego device, as represented by ego pose data, from the first time to the second time.

Clause 17. The apparatus of Clause 16, wherein to warp the first voxel grid to generate the third voxel grid, the one or more processors are further configured to: warp the first voxel grid using the ego pose data at the first and second times.

Clause 18. The apparatus of any of Clauses 16-17, wherein the ego device comprises an autonomous vehicle.

Clause 19. The apparatus of any of Clauses 13-18, wherein clustering the dynamic voxel flow comprises unsupervised density-based clustering.

Clause 20. The apparatus of any of Clauses 13-19, wherein to determine the velocity estimate for the dynamic object of the scene, the one or more processors are further configured to: determine the velocity estimate using a difference between the first time and the second time.

Clause 21. The apparatus of any of Clauses 13-20, wherein the one or more processors are further configured to: generate the first voxel grid by extracting features from the camera output images into one or more feature maps and applying a voxelization process to convert the one or more feature maps into the first voxel grid.

Clause 22. The apparatus of any of Clauses 13-21, wherein the camera output images of the scene are captured by a plurality of monocular cameras.

Clause 23. The apparatus of any of Clauses 13-22, wherein the dynamic voxel flow represents motion of voxels between the first time and the second time.

Clause 24. The apparatus of any of Clauses 13-23, wherein the one or more processors are further configured to: control an operation of a vehicle based at least in part on the velocity estimate for the dynamic object.

Clause 25. A non-transitory computer-readable storage medium storing instructions that, when executed, cause one or more processors to: warp a first voxel grid generated from camera output images of a scene captured at a first time to a third voxel grid representing the scene at a second time; generate a voxel flow from the first time to the second time based at least in part on a second voxel grid generated from camera output images of the scene captured at the second time and the third voxel grid; determine a dynamic voxel flow based at least in part on the voxel flow and an ego motion flow; cluster the dynamic voxel flow to identify one or more object instances; and determine a velocity estimate for a dynamic object of the scene from motion of the one or more object instances in the dynamic voxel flow.

Clause 26. The non-transitory computer-readable storage medium of Clause 25, wherein to generate the voxel flow, the instructions further cause the one or more processors to: pass the second voxel grid and the third voxel grid through a flow estimation network.

Clause 27. The non-transitory computer-readable storage medium of any of Clauses 25-26, wherein the ego motion flow represents motion of an ego device, as represented by ego pose data, from the first time to the second time.

Clause 28. The non-transitory computer-readable storage medium of Clause 27, wherein to warp the first voxel grid to generate the third voxel grid, the instructions further cause the one or more processors to: warp the first voxel grid using the ego pose data at the first and second times.

Clause 29. The non-transitory computer-readable storage medium of any of Clauses 25-28, wherein the camera output images of the scene are captured by a plurality of monocular cameras.

Clause 30. The non-transitory computer-readable storage medium of any of Clauses 25-29, wherein the instructions further cause the one or more processors to: control an operation of a vehicle based at least in part on the velocity estimate for the dynamic object.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
warping a first voxel grid generated from camera output images of a scene captured at a first time to a third voxel grid representing the scene at a second time;
generating a voxel flow from the first time to the second time based at least in part on a second voxel grid generated from camera output images of the scene captured at the second time and the third voxel grid;
determining a dynamic voxel flow based at least in part on the voxel flow and an ego motion flow;
clustering the dynamic voxel flow to identify one or more object instances; and
determining a velocity estimate for a dynamic object of the scene from motion of the one or more object instances in the dynamic voxel flow.

2. The method of claim 1, wherein generating the voxel flow comprises passing the second voxel grid and the third voxel grid through a flow estimation network.

3. The method of claim 1, wherein determining the dynamic voxel flow comprises subtracting the ego motion flow from the voxel flow.

4. The method of claim 1, wherein the ego motion flow represents motion of an ego device, as represented by ego pose data, from the first time to the second time.

5. The method of claim 4, wherein warping the first voxel grid to generate the third voxel grid comprises warping the first voxel grid using the ego pose data at the first and second times.

6. The method of claim 1, wherein clustering the dynamic voxel flow comprises unsupervised density-based clustering.

7. The method of claim 1, wherein determining the velocity estimate for the dynamic object of the scene comprises determining the velocity estimate using a difference between the first time and the second time.

8. The method of claim 1, further comprising:
generating the first voxel grid by extracting features from the camera output images into one or more feature maps and applying a voxelization process to convert the one or more feature maps into the first voxel grid.

9. The method of claim 1, further comprising:
controlling an operation of a vehicle based at least in part on the velocity estimate for the dynamic object.

10. An apparatus comprising:
a memory; and
one or more processors implemented in circuitry and in communication with the memory, the one or more processors configured to:
warp a first voxel grid generated from camera output images of a scene captured at a first time to a third voxel grid representing the scene at a second time;
generate a voxel flow from the first time to the second time based at least in part on a second voxel grid generated from camera output images of the scene captured at the second time and the third voxel grid;
determine a dynamic voxel flow based at least in part on the voxel flow and an ego motion flow;
cluster the dynamic voxel flow to identify one or more object instances; and
determine a velocity estimate for a dynamic object of the scene from motion of the one or more object instances in the dynamic voxel flow.

11. The apparatus of claim 10, wherein to generate the voxel flow, the one or more processors are further configured to:
pass the second voxel grid and the third voxel grid through a flow estimation network.

12. The apparatus of claim 10, wherein to determine the dynamic voxel flow, the one or more processors are further configured to:
subtract the ego motion flow from the voxel flow.

13. The apparatus of claim 10, wherein the ego motion flow represents motion of an ego device, as represented by ego pose data, from the first time to the second time.

14. The apparatus of claim 13, wherein to warp the first voxel grid to generate the third voxel grid, the one or more processors are further configured to:
warp the first voxel grid using the ego pose data at the first and second times.

15. The apparatus of claim 13, wherein the ego device comprises an autonomous vehicle.

16. The apparatus of claim 10, wherein clustering the dynamic voxel flow comprises unsupervised density-based clustering.

17. The apparatus of claim 10, wherein to determine the velocity estimate for the dynamic object of the scene, the one or more processors are further configured to:
determine the velocity estimate using a difference between the first time and the second time.

18. The apparatus of claim 10, wherein the one or more processors are further configured to:
generate the first voxel grid by extracting features from the camera output images into one or more feature maps and applying a voxelization process to convert the one or more feature maps into the first voxel grid.

19. The apparatus of claim 10, wherein the one or more processors are further configured to:
control an operation of a vehicle based at least in part on the velocity estimate for the dynamic object.

20. A non-transitory computer-readable storage medium storing instructions that, when executed, cause one or more processors to:
warp a first voxel grid generated from camera output images of a scene captured at a first time to a third voxel grid representing the scene at a second time;
generate a voxel flow from the first time to the second time based at least in part on a second voxel grid generated from camera output images of the scene captured at the second time and the third voxel grid;
determine a dynamic voxel flow based at least in part on the voxel flow and an ego motion flow;
cluster the dynamic voxel flow to identify one or more object instances; and
determine a velocity estimate for a dynamic object of the scene from motion of the one or more object instances in the dynamic voxel flow.
